(19) United States
(12) Patent Application Publication
(10) Pub. No.: US 2023/0410164 A1
(43) Pub. Date: Dec. 21, 2023

(54) ELECTRIC VEHICLE CHARGING SYSTEM CAPABLE OF INTEGRATED BILLING AND COLLECTION OF PARKING FEES AND ELECTRIC VEHICLE CHARGING FEES, AND INTEGRATED BILLING AND COLLECTION METHOD THEREOF

(71) Applicant: ECARPLUG CO., LTD., Seongnam-si (KR)

(72) Inventor: Kwangseob SHIN, Gwangju-si (KR)

(73) Assignee: ECARPLUG CO., LTD., Seongnam-si (KR)

(21) Appl. No.: 17/897,129

(22) Filed: Aug. 27, 2022

(30) Foreign Application Priority Data
Jun. 17, 2022 (KR) 10-2022-0074077

(51) Int. Cl. G06Q 30/04; B60L 53/66

(52) U.S. Cl. CPC G06Q 30/04; B60L 53/665; G06Q 2240/00

(57) ABSTRACT

An electric vehicle charging system capable of billing and collecting a parking fee together when to bill an electric vehicle charging fee, and a parking fee collection method thereof are proposed. More particularly, there are provided an electric vehicle charging system capable of collection and billing of parking fees, and a parking fee billing method thereof, wherein while providing convenience to users, various additional services such as parking fee discounts may be provided by enabling the users to pay the parking fees together with electric vehicle charging fees when electric vehicles are charged in a paid parking lot, and also since chargers are not equipped with license plate recognition systems, the electric vehicle charging system has a low price and few breakdowns thereof.

### CROSS REFERENCE TO RELATED APPLICATION

The present application claims priority to Korean Patent Application No. 10-2022-0074077, filed Jun. 17, 2022, the entire contents of which is incorporated herein for all purposes by this reference.

### BACKGROUND OF THE INVENTION

### Field of the Invention

The present disclosure relates to an electric vehicle charging system capable of collection and billing of parking fees and a parking fee billing method thereof and, more particularly to an electric vehicle charging system capable of collection and billing of parking fees and a parking fee billing method thereof, wherein while providing convenience to users, various additional services such as parking fee discounts may be provided by enabling the users to pay the parking fees together with electric vehicle charging fees when electric vehicles are charged in a paid parking lot, and also since a charger is not equipped with a license plate recognition system, the electric vehicle charging system has a low price and few breakdowns thereof.

### Description of the Related Art

In general, since most parking lots are operated for a fee, charging for parking fees is needed. In addition, when an electric vehicle charging device for electric vehicles is installed in a parking lot, billing for a charging fee for the electric vehicle charged through the electric vehicle charging device is necessary.

Accordingly, in a case where an electric vehicle is charged in a parking lot, billing for a charging fee as well as a parking fee should be made. However, in a conventional billing system, payment of the parking fee and payment of the charging fee are separately made, and accordingly, a user has inconvenience of having to process two payments.

That is, since the parking fee is calculated at a time of exiting the parking lot according to a parking time, the payment of the parking fee should be made at the time of exiting the parking lot, and also a place of payment is usually located at an exit side of the parking lot. Whereas, the electric vehicle charging fee is calculated according to a final charging amount after charging is completed or according to a charging amount set by a user before the charging, so the electric vehicle charging fee is determined at a time different from the time when the parking fee is confirmed.

In addition, in order to allow a user to pay the charging fee at the exit side of the parking lot, the payment should be made after the electric vehicle is separated from the electric vehicle charging device and then moved to the exit side of the parking lot, so there is a need for a method that may clearly confirm, at a position of a billing system at the exit side of the parking lot, information on whether the exiting vehicle is the vehicle that has been charged and information on the charging fee based on an actual result of the charging.

Meanwhile, as a related art, Korean Patent No. 10-1764070 provides an electric vehicle charging device and a parking space LPR device having a vehicle number recognition function, wherein there occurs a problem that a maintenance cost is increased due to an installation cost of an image acquisition part that acquires a license plate image of an entering vehicle, and due to periodic breakdowns.

According to an exemplary embodiment of Korea Patent No. 10-2308141, “METHOD OF PROVIDING PARKING LOT CHARGING SERVICE FOR BATTERY CHARGING OF ELECTRIC VEHICLES AND PARKING LOT CHARGING SYSTEM”, which is a parking lot charging service method and a parking lot charging system for battery charging of electric vehicles, charging requests may include a vehicle's battery capacity, a battery remaining amount, a battery charging type, a battery charging amount, and a payable maximum battery charge fee and parking time.

However, in a case of a low-speed battery charger, there occurs a problem that the information such as the vehicle's battery capacity, the battery remaining amount, and the battery charging type are unable to be acquired due to the current international standard technology.

Accordingly, the information is only able to be applied to a high-speed battery charger.

In addition, the various charging requests transmitted by user terminals may include the vehicle's battery capacity, the battery remaining amount, the battery charging type (e.g. high-speed, low-speed), the battery charging amount, the payable maximum battery charge fee and parking time, and device identification information may be fundamentally provided as well.

Here, the device identification information may include a vehicle's license plate number, a serial number, device owner information, a vehicle model, etc., which may be information recognizable by a parking lot management terminal to be described later.

However, in a case where license plate information provided to a server through a conventional user terminal is incorrectly entered, a serious error of charging another vehicle occurs.

Meanwhile, the parking lot management server may confirm that a vehicle enters any one parking lot through a parking lot management terminal, receive charging requests from a corresponding user terminal or the corresponding vehicle, and calculate a condition for charging and a first battery charging price of the corresponding vehicle on the basis of vehicle identification information and the charging requests of the vehicle.

For example, on the basis of a current battery remaining amount, a desired battery charging amount, and a battery charge fee payable among the charge requests, the parking management server may calculate a battery charging amount to be maximally charged in a parking lot, and the calculated battery charging amount may be the condition for charging.

However, the fact that the parking management server receives the charging requests from the user terminal or the vehicle at a time when the vehicle enters the parking lot is unrealistic and difficult to be applied.

In addition, the parking lot management server may transmit a charging fee accumulated in a current vehicle, charging fee settlement status, point status, and the like to the user terminal or the vehicle together with the first battery charging price.

The parking lot management server may control an operation of the parking lot management terminal according to whether the first battery charging price of the vehicle is processed by the user terminal or the vehicle.

However, since the above-described method is not an integrated billing method for parking fees and charging fees, user convenience is reduced.

Korea Patent No. 10-2314126 is an integrated management method for charging fees and parking fees of electric vehicles, and a system for executing the same.

However, the said system may only be realized by installing a license plate recognition system on a charger, so adding a license plate recognition function requires a significant budget, which may cause an obstacle to the spread of the said system.

As described above, referring to fundamental differences between the related art and the present disclosure, 1) A conventional parking fee+charging fee billing system, which is similar to the embodiment of the present disclosure, should be provided with a camera for a parking control system to recognize a license plate at an entrance to a parking lot and a camera for a charger to recognize the license plate.

2) To compensate for this requirement, some systems allow a user to enter a vehicle number by himself or herself through a screen instead of the camera in the charger (refer to the details of the above-described disclosure).

However, in this case, when the user happens to enter a vehicle number of another vehicle, there is no way to verify this number, so there is an error that a charging fee is billed to another vehicle.

The present disclosure is an invention that solves the disadvantages of 2), and the fact that a license plate number is input without installing a camera for recognizing the license plate in the charger is the same as in the case of 2).

However, the embodiment of the disclosure of 2) has advantages where it is possible to add up a parking fee and a charging fee on the basis of the parking fee when the vehicle exits and the license plate number entered by the user and to provide additional services such as various discounts.

The present disclosure is a method in which a vehicle number is input by a user through an input device for receiving a license plate number of a vehicle to be charged (e.g. inputting a vehicle number through an LCD display mounted on a charger, or through a user's smartphone or an RFID card), and based on this, when the charging fee is paid, the parking fee is added thereto and then paid together.

As such, this method is to pay in advance the parking fee for the license plate number entered by a user himself or herself, thereby preventing the user from having the disadvantage of 2) of entering a license plate number of another vehicle. That is, when entering a license plate number of another vehicle, the user himself and herself should pay both his or her own parking fee and the parking fee of another vehicle, so the user is supposed not to make such an error.

For the parking fee paid in advance in this way, a charger control system notifies the parking control system of information about the paid parking fee, so that it is possible for the vehicle to exit without paying the fee when leaving. In addition, in a case where the license plate number is not input into the charger, only the charging fee is paid and the parking fee is paid in the same way as in the existing system when the vehicle exits.

That is, when the user enters a different license plate number as in 2), not only the user has to pay the parking fee for another vehicle instead, but also the user has to pay his or her own parking fee when leaving, so intentional entering of the license plate number of another vehicle by the user may be prevented.

### DOCUMENTS OF RELATED ART

### Patent Documents

[Patent Document 1] Korean Patent No. 10-1764070
[Patent Document 2] Korean Patent No. 10-1729450
[Patent Document 3] Korean Patent No. 10-2056561

### SUMMARY OF THE INVENTION

An objective of the present disclosure for solving the above-described problems is to provide an electric vehicle charging system capable of collection and billing of parking fees in order to resolve user inconvenience caused by the payment of charging fees and the parking fees separately, and provide rate discount methods easily according to the use of dual services of parking and charging, when electric vehicles are charged in a paid parking lot.

In addition, another objective of the present disclosure is to provide a method of charging and paying two kinds of fees at the same time by using a normal charger having no license plate recognition function and to realize functions of the method because such functions are provided by adding the license plate recognition function to the charger in the past, but the adding of the license plate recognition function takes a significant budget, which causes the obstacle to the spread of the said system.

The embodiment of the present disclosure to solve the above problems is provided with a method including: confirming membership status or receiving a vehicle number of a non-member by information guidance when an electric vehicle accesses an electric vehicle charger including an electric vehicle charging service server; displaying the vehicle number on a display device or outputting the vehicle number in a voice through a voice output device by retrieving the vehicle number from a database when the electric vehicle charging service server determines that an owner of the corresponding vehicle is a member; and performing collective billing of a parking fee and an electric vehicle charging fee according to information of the member by retrieving the information of the member who manages the electric vehicle matching the vehicle number from the database and by receiving an entry time of the vehicle number from a parking control system after the electric vehicle charging service server completes charging of the electric vehicle.

The displaying of the vehicle number on the display device or the voice output device may further include receiving, by the electric vehicle charging service server, confirmation of whether the vehicle number matches or not from the owner of the vehicle by outputting the vehicle number to the display device or the voice output device of the electric vehicle charger.

The confirming of the membership status may further include: determining, by the electric vehicle charging service server, the membership status on the basis of vehicle information corresponding to the confirmed vehicle number; and performing, by the electric vehicle charging service server, a billing function on the basis of the membership status.

The method may further include: providing, by the electric vehicle charging service server, a selection of whether to perform membership registration to the owner of the vehicle when the owner of the corresponding vehicle is determined to be the non-member in the confirmation of the membership status, and proceeding with a membership registration procedure when the owner of the corresponding vehicle selects the membership registration; and performing the collective billing of the parking fee and the electric vehicle charging fee by requesting the parking fee of the corresponding vehicle to the parking control server.

The method may further include operating the electric vehicle charging service server by generating a connection signal when the electric vehicle accesses the electric vehicle charger.

The embodiment of the present disclosure is provided with a system including: a member information acquisition and transmission part connected to a database for storing member information and configured to provide member confirmation information, which confirms whether an owner of an electric vehicle accessing an electric vehicle charger is a member or not, to an electric vehicle charging service server; the electric vehicle charging service server configured to acquire a vehicle number from a member DB by confirming membership status through the member information acquisition and transmission part when the electric vehicle accesses; and a parking fee and electric vehicle charging fee collective billing part configured to perform, after charging is completed, collective billing of a parking fee and an electric vehicle charging fee according to the member information of the member who manages the electric vehicle.

The member information acquisition and transmission part operated in the electric vehicle charging service server may include: a tagging and insertion part configured to receive information by tagging or inserting a plastic card having a communication function in a card reader installed in an electric vehicle charger; and a QR code part configured to acquire the member information through a recognition part including a two-dimensional or three-dimensional QR code.

The system may further include a license plate input part configured to receive the vehicle number through an LCD screen of the charger or the license plate recognized by a user's mobile communication device or a user's voice.

The embodiment of the present disclosure is provided with a method including: recognizing, by a parking control server, a license plate when an electric vehicle enters, and allowing the electric vehicle to proceed with parking; confirming whether a member or a non-member meets a condition for charging after the parking; acquiring a vehicle number or a phone number through a membership card or a smartphone in a case of the member, or acquiring the vehicle number or the phone number through an input part in a case of the non-member; acquiring the vehicle number through the membership card or the smart phone or a license plate input part, setting information on parking fee and charging fee processing by an electric vehicle charging service server, and displaying the information on a display device of an electric vehicle charger or outputting the information in a voice; obtaining the phone number through the membership card or the smart phone or the license plate input part; setting, by the electric vehicle charging service server, charging termination and information guidance, and displaying the same on the display device of the electric vehicle charger or outputting the same in the voice; performing a charging service by the electric vehicle charging service server; terminating the charging by the electric vehicle charging service server; and performing a billing function according to the parking fee and the charging fee corresponding to the vehicle number or the phone number.

The method of claim 9, wherein, in the setting of the information on the parking fee and charging fee processing by the electric vehicle charging service server, discount or additional service information is set (i.e. set and displayed), so as to display the discount or additional service information on the display device of the electric vehicle charger or outputting the discount or additional service information in the voice and apply the discount or additional service information to a discount additional service.

The method may further include confirming, by the electric vehicle charging service server, whether the vehicle number acquisition is correctly performed, and entering and confirming the vehicle number again when the vehicle number is incorrectly entered.

In the present disclosure, the method may further include: recognizing, by the parking control server, the license plate when the vehicle exits; confirming, by the parking control server, whether the parking fee is collected by the charging service server; calculating and collecting, by the parking control server, the parking fee when the parking fee is not collected by the charging service server; and proceeding, by the parking control server, with a vehicle exit process of raising a blocking bar.

According to the above-described configuration, the present disclosure may increase user convenience by adding up a charging fee and a parking fee of an electric vehicle and allowing a user to pay the fees at the same time.

In addition, in the present disclosure, when two services are used at the same time, rate discounts or various promotions may be provided easily.

In addition, since the present disclosure is not provided with a license plate recognition system in a charger unlike the conventional method, the system price is low and there are few breakdowns.

### BRIEF DESCRIPTION OF THE DRAWINGS

FIG. 1 is a view illustrating a schematic configuration of an electric vehicle charging system capable of collection and billing of parking fees according to an exemplary embodiment of the present disclosure.

FIGS. 2A and 2B are a view illustrating a detailed configuration of the electric vehicle charging system capable of the collection and billing of the parking fees according to the exemplary embodiment of the present disclosure.

FIG. 3 is a view illustrating a detailed configuration of an electric vehicle charging service server (i.e. a member management part) capable of the collection and billing of the parking fees according to the exemplary embodiment of the present disclosure.

FIG. 4 is a view illustrating a schematic configuration of an input part according to the exemplary embodiment of the present disclosure.

FIG. 5 is a view illustrating a parking fee billing method (i.e. a process of collectively paying the parking fee and an electric vehicle charging fee, and others) using the electric vehicle charging system capable of the collection and billing of the parking fee according to the exemplary embodiment of the present disclosure.

FIGS. 6A and 6B are a view illustrating the parking fee billing method (i.e. member registration confirmation) using the electric vehicle charging system capable of the collection and billing of the parking fee according to the exemplary embodiment of the present disclosure.

FIG. 7 is a view illustrating the parking fee billing method (i.e. a registration process for a non-member) using the electric vehicle charging system capable of the collection and billing of the parking fee according to the exemplary embodiment of the present disclosure.

FIG. 8 is a view illustrating the detailed parking fee billing method using the electric vehicle charging system capable of the collection and billing of the parking fee according to the exemplary embodiment of the present disclosure.

### DETAILED DESCRIPTION OF THE INVENTION

The singular forms used in the present disclosure are intended to include the plural forms as well, unless the context clearly indicates otherwise. In the present disclosure, terms such as “consisting of” or “comprising” should not be construed as necessarily including all of the various components or various steps described in the disclosure, and it should be construed that some components or some steps among the various components or various steps may not be included, or additional components or steps may be further included.

Hereinafter, a preferred exemplary embodiment according to the present disclosure will be described in detail with reference to the accompanying drawings, but regardless of the reference numerals, the same or similar components are given the same reference numbers, and the overlapping description thereof will be omitted.

In addition, in describing the present disclosure, when it is determined that a detailed description of a related known technology may obscure the subject matter of the present disclosure, the detailed description thereof will be omitted. In addition, it should be noted that the accompanying drawings are only for easy understanding of the spirit of the present disclosure, and should not be construed as limiting the spirit of the present disclosure by the accompanying drawings.

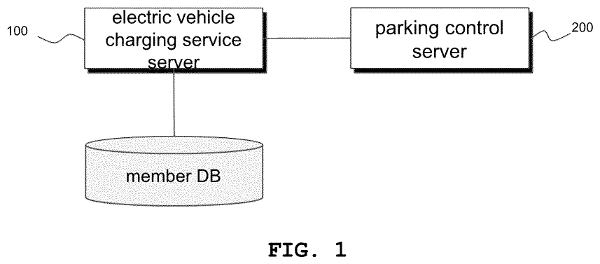

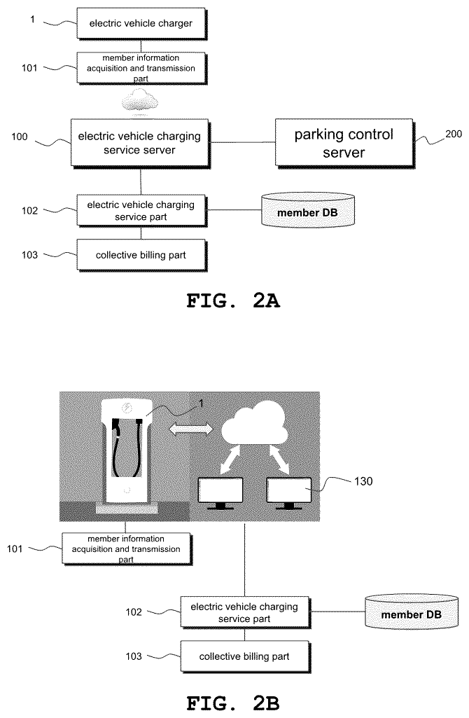

FIG. 1 is a view illustrating a schematic configuration of a relationship between a parking control server, an electric vehicle charging service server, and a member DB, which belong to an electric vehicle charging system capable of collection and billing of parking fees according to an exemplary embodiment of the present disclosure, and FIGS. 2A and 2B are a view illustrating a detailed configuration of the electric vehicle charging system capable of the collection and billing of the parking fees according to the exemplary embodiment of the present disclosure.

The electric vehicle charging service server 100 and the parking control server 200 may have the same configuration as a typical web server in hardware, and in software, may include program modules that perform various functions, the program modules being implemented through various types of languages such as JAVA, PHP, C#, ASP, etc. In addition, the electric vehicle charging service server 100 and the parking control server 200 may be implemented on general server hardware by using web server programs provided in various ways depending on operating systems such as DOS, Windows, Linux, Unix, macOS for Macintosh, Android, iOS, etc.

AS shown in FIGS. 1, 2A, and 2B, when an electric vehicle accesses a member information acquisition and transmission part 101, which is connected to a database (DB) for storing member information and is configured to provide member confirmation information for confirming membership status of a vehicle owner accessing a charging station to the electric vehicle charging service server, membership status is determined by transmitting the member information (i.e. ID) acquired through the member information acquisition and transmission part 101 to a charging control server.

The embodiment of the present disclosure includes: an electric vehicle charging service part 102 configured to acquire a vehicle number from a member DB; and a collective billing part 103 for parking fees and electric vehicle charging fees configured to perform collective billing of a parking fee and an electric vehicle charging fee after charging is completed according to the information of the member who manages the electric vehicle.

The embodiment of the present disclosure may proceed with membership registration in advance before using the charging and parking service by downloading a membership registration application to a member terminal that may proceed with the membership registration in advance by the member information acquisition and transmission part 101.

In this case, the member information acquisition and transmission part 101 may include a specific app to enable the membership registration in advance, and a member terminal usable for this end is an electronic device possessed by a user, and may be a device that includes a communication function for interworking with a real card.

For example, the electronic device may include at least one of the following device: a smartphone, a tablet personal computer, a mobile phone, a video phone, an e-book reader, a desktop personal computer (PC), a laptop personal computer, a netbook computer, a personal digital assistant (PDA), a portable multimedia player (PMP), an MP3 player, a mobile medical device, a camera, a wearable device (e.g., a head-mounted-device (HMD) such as electronic glasses), an electronic garment, an electronic bracelet, an electronic necklace, an electronic accessory, an electronic tattoo, or a smart watch.

For example, a wearable watch among wearable devices recognizes a predetermined gesture composed of yaw, pitch, or roll, and when the predetermined gesture is recognized, membership status may be determined by comparing the member DB with personal information such as a vehicle number and a phone number, the personal information being acquired by transmitting a gesture only when the gesture is rolled by an angle greater than or equal to a reference value through setting an angle reference value of the rolling.

In this case, the electric vehicle charger 1 and the wearable watch, having respective Bluetooth modules installed therein, may exchange information with each other through a local area network using components such as the Bluetooth modules.

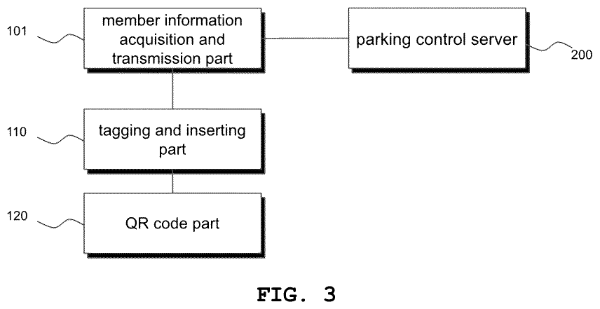

As shown in FIGS. 2(b) and 3, the member information acquisition and transmission part 101 to be attached to the electric vehicle charger 1 includes: a tagging and inserting part 110 configured to receive information (i.e. a vehicle number and/or a phone number) by tagging or inserting a plastic card having a communication function; and a QR code part 120 configured to allow the vehicle number and/or the phone number to be input through a recognition part including a two-dimensional or three-dimensional QR code.

The member information acquisition and transmission part 101 further includes a proximity sensor configured to generate a proximity signal to operate the electric vehicle charging service server when an electric vehicle is close to the electric vehicle charger 1.

Specifically, a short-distance sensor uses a PIR sensor, and serves as a sensor passively responding to infrared rays emitted from an object, thereby responding to the approach of an electric vehicle.

In this case, it is possible to detect infrared rays emitted from heat generated by the electric vehicle or heat generated from the human body.

In addition, the short-distance sensor may use a Bluetooth detection sensor (for a smartphone), an ultrasonic sensor, a beacon, and the like, thereby being connected to a member terminal through a network.

The PIR sensor is a sensor utilizing a pyroelectric effect that converts incident infrared rays into a voltage form to enable photodetection, and is made of crystalline metal. When heat is applied to an area of the PIR sensor exposed to infrared light, electric charges are generated on a surface of the area thereof.

The PIR sensor has various types depending on the intended use. The PIR sensor is divided into three-dimensional, a planar, and a spot types according to a shape of a detection area thereof, is divided into short-range, medium-range, and long-range types according to a detection distance, and is divided into wall-mounted and ceiling-mounted types according to a fixation form.

In the PIR sensor, the three-dimensional type is used to detect a wide area with a horizontal detection angle of 45 degrees or more, the planar type is used to detect a narrow area with a horizontal detection angle of 20 degrees or less, and the spot type is a type installed on an upper part of the electric vehicle charger 1 and configured to detect 360 degrees of a lower part thereof, and is installed in the middle of a cross-shaped parking lot or in the middle of a parking lot, so as to be used to detect 360 degrees as well.

As an exemplary embodiment, the present disclosure uses a laser Doppler velocimeter as a measurement aid means for an approaching electric vehicle.

A Doppler sensor used in the present disclosure is a velocity measurement device using the Doppler effect.

The Doppler effect refers to a phenomenon in which the frequency of light scattered from a moving object shifts from the frequency of incident light depending on a movement speed of the object.

When a plurality of sensors described above is combined and used, the combined sensors may be used readily in an integrated calculation of a parking lot usage time after charging in the parking control server 200 (in a case where a charging time and a parking time are mismatched or in a case where a predetermined period of time has elapsed after a parking fee is settled).

An electronic device interworked with or inserted into the tagging and inserting part 110 according to the present disclosure to perform a specific function may be one or a combination of more various devices described above. In addition, the electronic device according to the present disclosure may be a flexible device. In addition, it is apparent to those skilled in the art that the electronic device according to the present disclosure is not limited to the above-described devices.

The real card, which is tagged or inserted into the tagging and inserting part 110, is equipped with a communication function capable of communicating with the electric vehicle charging service server 100 and a payment module for performing payment, so as to be realized in a form of real card (e.g. in a form of a square plastic card). As an exemplary embodiment, the real card may be realized in a form of a contact and/or contactless card, such as an IC card or a Combi card.

The above-mentioned IC card and Combi card are a type of card that stores card information in a form of an applet in an IC chip. A real card may be realized in a form of a smart card, which is an electronic card capable of storing a large amount of information by mounting an integrated circuit (IC) memory element, may have one or more ICs built therein. There may be various real cards used for financial institution cards, medical insurance cards, transportation cards, credit cards, USIM cards, and the like.

As an exemplary embodiment, a real card may be registered using a service application running on a member terminal (i.e. a mobile terminal), and may manage usage details. For example, card information may be recognized by scanning a barcode included in the real card with the mobile terminal, or the card information may be directly input, and a mobile card corresponding to the real card may be registered in the service application of the mobile terminal.

The mobile terminal and the real card may be registered or linked by tagging by directly using short-distance communication (e.g., NFC) in addition to such barcodes or QR codes.

As an exemplary embodiment, the mobile terminal or real card of the user may provide a function of payment using Near Field Communication (NFC), payment using barcodes or QR codes, and payment using an IC chip, and may include various contact-type and/or contactless-type (i.e. Combi card) payment functions.

For example, even when a member does not run an application on the terminal, the member may manage the start of charging, completion of the charging, and the like through NFC tagging.

That is, by accumulating the charging amounts, charging times, and the like to perform statistics, and visually providing discount benefits and the like to a display device, it is possible to confirm in advance the discount benefits that may lead to economic savings on user's electric vehicle charging and payment.

As an exemplary embodiment, in the case of a member, payment may be conveniently performed with points or amount of money earned through pre-payment. In addition, simple payment may be performed through a pre-registered payment method without additionally performing a separate card payment. Available payment methods may include cards, various simple payment services, cash, points, cryptocurrency, and the like. When a payment method is the cryptocurrency, payment may be performed through a cryptocurrency wallet address registered in advance by a member.

Here, the payment method may include an existing card, various simple payment services, cash, points, and cryptocurrency. Examples of cryptocurrencies available for payment may include representative cryptocurrencies such as Bitcoin, Ethereum, and Ripple.

For example, the payment proceeds in such a way that a balance of an electronic wallet is confirmed by means of a smartphone owned by a member, a withdrawal request and a transaction request amount are received by means of the smartphone, and the transaction request amount and transaction availability for the member's electronic wallet are confirmed from a cryptocurrency exchange server according to the confirmation of the member by means of a display device.

As another exemplary embodiment, the embodiment may be configured in such a way that a user purchases a cryptocurrency and secures the cryptocurrency in an electronic wallet, and among an electric vehicle charging service server 100 for selling and managing discount event tickets online and a cryptocurrency exchange server provided in an exchange that supports cryptocurrency transactions, the user purchases a cryptocurrency by connecting to the cryptocurrency exchange server and purchases a mobile ticket corresponding to a discount event by connecting to the electric vehicle charging service server 100, thereby using the cryptocurrency and the mobile ticket when parking and charging an electric vehicle.

In this case, by using the cryptocurrency, the determination of membership status may be conducted conveniently, and the electric vehicle charging service server may also quickly provide a billing function on the basis of the membership status.

As yet another embodiment, a more reliable alternative may be proposed in acquiring a vehicle number and a personal number, which are sensitive personal information, by using a blockchain technology interworking with cryptocurrency.

For example, the method of the present disclosure may include: allowing a member terminal and an electric vehicle charging service server 100 to be connected to a cryptocurrency exchange server (or a blockchain system); receiving discount voucher information by requesting the discount voucher information from a member terminal to the electric vehicle charging service server 100; and inquiring a plurality of pieces of discount voucher information from the member terminal, determining a discount voucher to be purchased on the basis of the plurality of pieces of discount voucher information, and paying settlement costs for the purchase-confirmed discount voucher with a cryptocurrency used in a cryptocurrency exchange server.

As another example, more diverse cryptocurrencies may be used, and the method of the present disclosure may include: receiving firstly information about a member wallet address of a sender, a recipient wallet address of a recipient (e.g. an electric vehicle charging service server 100), and a cryptocurrency transfer amount; recognizing an identifier related to a type of cryptocurrency included in the member wallet address; recognizing an identifier related to a type of cryptocurrency included in the recipient wallet address; and recording each transmission detail in a block by transmitting each transmission detail to at least one node included in a blockchain network according to the cryptocurrency on the basis of the identifiers.

Alternately, the electric vehicle charger 1 includes a memory, a communication circuit, and a processor, wherein the processor may be set to receive, from a member terminal, a message including a blockchain address and identification data for identifying a blockchain network in which the valid blockchain address exists, access at least one blockchain network related to the blockchain address prior to remitting a cryptocurrency to the blockchain address, confirm information indicated by the identification data through a node included in the at least one blockchain network, and determine whether to remit the cryptocurrency to the blockchain address according to whether the information indicated by the identification data matches the information related to the blockchain address (by displaying the same on a display device).

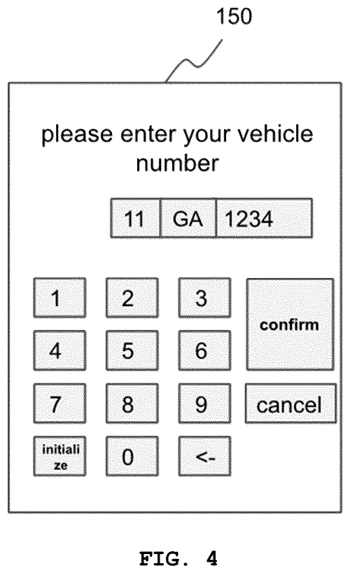

FIG. 4 is a view illustrating a schematic configuration of an input part according to the exemplary embodiment of the present disclosure.

As shown in FIG. 4, the present disclosure may include a license plate input part 150 configured to input manually a vehicle number of an electric vehicle and/or a driver's phone number.

In preparation for such manual inputting, an RF card may be used as an automatic input means. In addition, other cards capable of communication by using a specific control signal while protecting personal information may also be used.

As another exemplary embodiment, a vehicle owner may be prompted to input his or her four-digit vehicle number, and this information may be transmitted to a parking control server 200, so as to confirm the presence of a corresponding vehicle once again. When the vehicle inquired in the above step exists, an on-going process returns to a step of finally confirming a customer's vehicle once again to receive the final confirmation of the vehicle owner. Here, when there are two or more vehicles searched by the four-digit vehicle number, a user interface for providing a list of the corresponding vehicles and allowing the vehicle owner to select his or her own vehicle may be provided.

Accordingly, such an application of the method means that a user pays in advance a parking fee for a license plate number entered by the user himself or herself, thereby preventing the user from entering a license plate number of another vehicle. As for the vehicle parking fee that is paid in advance in this way, a charger control system notifies the parking control system of information about the paid parking fee, so that when a vehicle exits, it is possible for the vehicle to exit without paying the parking fee.

That is, when the user enters a different license plate number, not only the user has to pay the parking fee for another vehicle instead, but also the user has to pay his or her own parking fee when leaving, so intentional entering of the license plate number of another vehicle by the user may be prevented.

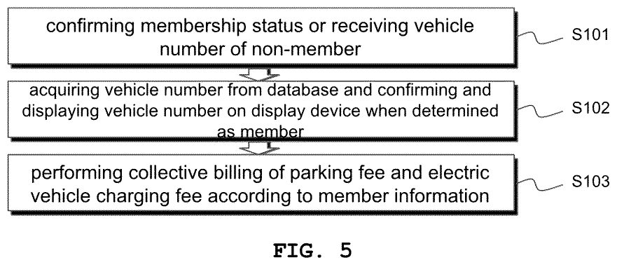

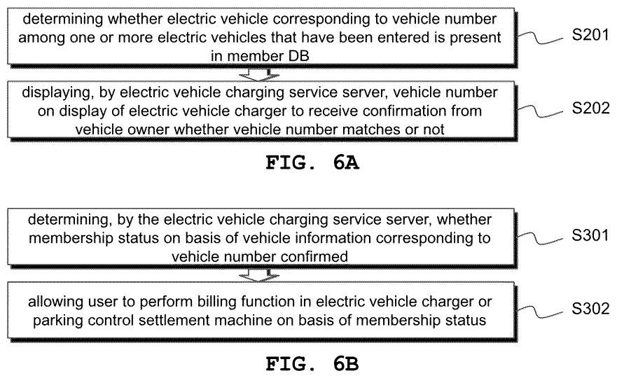

FIG. 5 is a view illustrating a parking fee billing method (i.e. a process of collectively billing the parking fee and an electric vehicle charging fee, and others) using the electric vehicle charging system capable of the collection and billing of the parking fee according to the exemplary embodiment of the present disclosure. FIGS. 6A and 6B are a view illustrating the parking fee billing method (i.e. member registration confirmation) using the electric vehicle charging system capable of the collection and billing of the parking fee according to the exemplary embodiment of the present disclosure.

As shown in FIG. 5, when an electric vehicle accesses an electric vehicle charger including an electric vehicle charging service server, confirming whether a vehicle owner is a member or receiving a vehicle number of a non-member according to information guidance is performed in step S101.

In step S102, when the electric vehicle charging service server determines that the vehicle owner is the member, a vehicle number is acquired from a member database, the vehicle number is temporarily stored in order to provide the vehicle number to a parking control system, and confirmation is performed by displaying the vehicle number on a display device.

After charging of the electric vehicle is completed, the electric vehicle charging service server retrieves information of the member who manages the electric vehicle matching the vehicle number from the database, whereby in step S103, a parking fee and an electric vehicle charging fee according to the member's information are collectively billed.

After performing the collective billing in step S103, billing details (i.e. whether or not the parking fee has been billed) along with the vehicle number may be transmitted to the parking control system to determine whether to additionally collect the parking fee when the vehicle exits (i.e. in a case where the parking fee is not paid or a predetermined amount of time has elapsed after the payment of the parking fee, an additional parking fee may be collected).

As shown in FIG. 6A, step S102 of displaying the vehicle number to the display device further includes: step S201 of determining whether the vehicle number of the vehicle accessed the electric vehicle charger 1 among one or more electric vehicles that has been entered is present in the member DB of the charging service server; and step S202 of displaying the vehicle number on a display of the electric vehicle charger or outputting the vehicle number in a voice by the electric vehicle charging service server, so as to receive confirmation from the vehicle owner whether the vehicle number matches.

As shown in FIG. 6B, step S102 of confirming whether the vehicle owner is the member further includes: step S301 of determining, by the electric vehicle charging service server, the membership status on the basis of vehicle information corresponding to the confirmed vehicle number; and step S302 of performing, by the electric vehicle charging service server, a billing function on the basis of the membership status.

In this case, a step of generating a connection signal when the electric vehicle accesses the electric vehicle charger 1 to operate the electric vehicle charging service server may be further included.

That is, in the related art, a camera for recognizing a license plate at an entrance should be provided, and a charger should also be provided with a camera for recognizing the license plate, but in the present disclosure, efficient charging and parking management operations are able to be performed by calculating whether the vehicle is charged or whether the vehicle is parked (i.e. a parking time) through a simple proximity sensor.

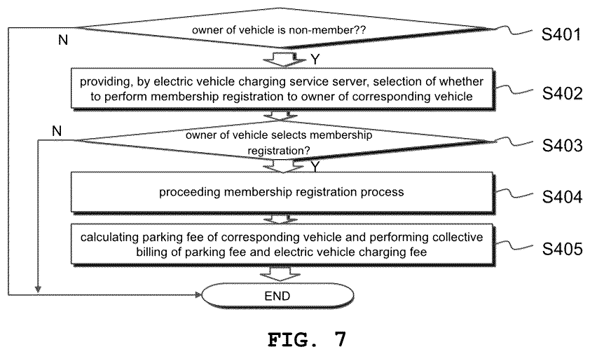

FIG. 7 is a view illustrating the parking fee billing method (i.e. a registration process in the case of the non-member) using the electric vehicle charging system capable of the collection and billing of the parking fee according to the exemplary embodiment of the present disclosure.

As shown in FIG. 7, in the present disclosure as an exemplary embodiment, when a vehicle owner of a vehicle is determined as a non-member by confirming whether the vehicle owner is the non-member in step S401, an electric vehicle charging service server provides a selection of whether to join a membership to the vehicle owner of the corresponding vehicle in step S402.

In addition, when the vehicle owner selects membership registration in step S403, a membership registration procedure is proceeded consecutively in step S404. In a case where the membership registration is not selected, the step of the membership registration is omitted.

Accordingly, the electric vehicle charging service server according to the present disclosure may calculate a parking fee of the corresponding vehicle and perform collective billing of the parking fee and the electric vehicle charging fee in step S405.

As another exemplary embodiment, when the vehicle owner desires the collective payment, the parking fee together with the non-member charging fee may be collectively paid.

In this way, when the non-member vehicle owner selects the collective payment, the collective billing is completed by the electric vehicle charging service server 100 on the basis of corresponding selection information and information about the collective billing such as an electric vehicle charging fee and a discount amount, and the information may be transmitted to the parking control server 200.

When the non-member vehicle owner selects the collective payment and finally arrives at a parking settlement machine through the vehicle exit, the collective payment may be performed by the non-member vehicle owner in the parking control server 200.

In this case, after the non-member vehicle owner completes the collective payment and finally arrives at the parking settlement machine for exiting his or her car, the parking control server 200 may charge an additional parking fee and allow the vehicle owner to perform payment in a case where the parking fee was excluded from settlement at a time when the vehicle owner made the collective payment at the charger, or a predetermined amount of time has elapsed after the parking fee has been settled even when the parking fee has been paid.

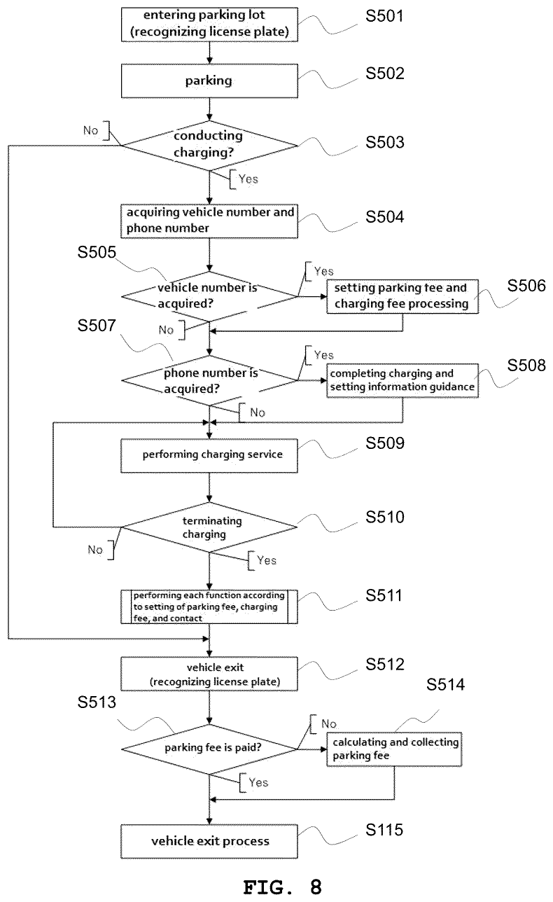

FIG. 8 is a view illustrating the detailed parking fee billing method using the electric vehicle charging system (i.e. the electric vehicle charging service server) capable of the collection and billing of the parking fee according to the exemplary embodiment of the present disclosure.

As shown in FIG. 8, first, member registration may be performed through an app for an electric vehicle charging system capable of collection and billing of parking fees.

The parking control server recognizes a license plate when an electric vehicle enters, and proceeds to allow the electric vehicle to be parked in steps S501 and S502.

After the electric vehicle is parked, the parking control server confirms whether a member or a non-member meets a condition for charging in step S503.

In step S504, in a case of a member, a vehicle number and/or a phone number is acquired through a member card or a smartphone, or in a case of a non-member, the vehicle number and/or the phone number is acquired through an input part.

In steps S505 and S506, the vehicle number is acquired through the membership card or the smartphone or the license plate input part, and the electric vehicle charging service server sets parking and charging fee processing information, and displays the information on the display device of the electric vehicle charger or outputs the information in voice.

In step S507, the phone number is acquired through the membership card or the smart phone or the license plate input part.

In step S508, the electric vehicle charging service server sets the charging completion and information guidance, so as to display the same on the display device of the electric vehicle charger or outputs the same in voice.

Here, even though the vehicle number or the phone number is not acquired, the next step, which is step S509 of performing a charging service, is performed, because only just a charging completion notification function and the like are not performed after the charging is completed,

In step S509, the electric vehicle charging service server performs the charging service.

In step S510, the electric vehicle charging service server terminates the charging.

In step S511, a billing function is performed according to the parking fee and the charging fee corresponding to the vehicle number and/or the phone number.

In step S512, the parking control server recognizes the license plate when the vehicle exits.

In step S513, the parking control server confirms whether the parking fee has paid.

When the parking fee is not paid, the parking control server calculates and collects the parking fee in step S514.

Finally, in step S515, the parking control server proceeds with an exit process of raising a blocking bar.

Although not shown in the drawings, the present disclosure includes various additional exemplary embodiments as follows.

As an exemplary embodiment, the method includes: measuring, by a battery state estimation device included in an electric vehicle charger 1, time series three pieces of change data of voltage, current and temperature and combining the same together, so as to match capacity at a corresponding time point with the time series three pieces of change data changed depending on a cycle on the basis of a time of charging constant current and constant voltage for a target battery in which various patterns of battery deterioration due to previous random discharge are reflected in profiles during the battery charging, thereby pre-learning the measurement data set by reflecting a correlation between pieces of time-series data, although storing the time series three pieces of change data as a measurement data set for machine learning; receiving, by the battery state estimation device, a combination of the three profiles of voltage, current, and temperature measured from the target battery; predicting, by the battery state estimation device, current capacity of the target battery by referring to the pre-learned data using the combination of the input profiles of the target battery; and deriving, by the battery state estimation device, performance of the target battery from the predicted current capacity.

An artificial intelligence module that stores the three pieces of change data as the measurement data set for the machine learning and pre-learns the same by reflecting the correlation between the pieces of time-series data may be a hardware module and/or a software module for operating an artificial intelligence network, and may determine or generate a predetermined threshold on the basis of the artificial intelligence network.

In addition, the artificial intelligence module may determine or set the predetermined threshold by using machine learning on big data stored in a storage module.

In addition, the artificial intelligence module trains the artificial intelligence network by using the big data, stored in a member DB, as an input variable. Specifically, the artificial intelligence module uses a deep learning technique, which is a field of machine learning, and performs the training so that an accurate correlation may be derived.

For example, the artificial intelligence module may train the artificial intelligence network by using member information acquired through the electric vehicle charging service server 100, a predetermined battery threshold, and the like, as learning data. For example, the artificial intelligence module may determine or reset the predetermined threshold by using the learned artificial intelligence network.

In addition, respective weights of a plurality of inputs in the function may be calculated through learning, that is, through deep learning of the artificial intelligence module.

In addition, as artificial intelligence network models used for such learning, various models may be used, such as Recurrent Neural Network (RNN), Deep Neural Network (DNN), and Dynamic Recurrent Neural Network (DRNN).

Here, the recurrent neural network (RNN) serves as a deep learning technique that takes into account both current data and past data at the same time, and in the recurrent neural network (RNN), a connection between units constituting an artificial neural network represents a neural network that constitutes a directed cycle.

Furthermore, various methods may be used for a structure that may be used to constitute the recurrent neural network (RNN). For example, representative examples include: a fully recurrent network, a Hopfield network, an Elman Network, and an echo state network (ESN), a long short-term memory network (LSTM), a bi-directional RNN, a continuous-time RNN (CTRNN), a hierarchical RNN, a secondary RNN, etc. In addition, as a method for training the recurrent neural network (RNN), a gradient descent method, a Hessian free optimization, a global optimization method, and the like may be used.

As yet another exemplary embodiment, an electric vehicle charger 1 includes: a short-range wireless communication part configured to establish a connection with a short-range wireless communication module mounted on an electric vehicle and transmit charging information to the electric vehicle, wherein the charging information is provided with information on electric vehicle identification information, a charging start time, a charging end time, and a charging amount, is transmitted to an electric vehicle charging service server 100 through a mobile communication network connected to a telematics system built into the electric vehicle, and may be used by a power provider linked to the electric vehicle charging service server 100 to generate charging information for the electric vehicle.

As still another exemplary embodiment, billing is made through a collective billing part 103 for parking fees and electric vehicle charging fees, the payment is made by authentication through a user terminal device at a time of payment, and when a pre-charged amount is insufficient, an operation for charging an additional amount with the user terminal device may be performed.

As an example, in the case of a member, the payment may also be conveniently performed with points or amount of money earned through pre-payment. In addition, simple payment may be performed through a pre-registered payment method without additionally performing a separate card payment. Available payment methods may include cards, various simple payment services, cash, points, cryptocurrency, and the like. When a payment method is cryptocurrency, payment may be performed through a cryptocurrency wallet address registered in advance by the member.

What is claimed is:

1. A parking fee billing method using an electric vehicle charging system capable of collection and billing of parking fees, the method comprising:
confirming membership status or receiving a vehicle number of a non-member by information guidance when an electric vehicle accesses an electric vehicle charger including an electric vehicle charging service server;
displaying the vehicle number on a display device or outputting the vehicle number in a voice through a voice output device by retrieving the vehicle number from a database when the electric vehicle charging service server determines that an owner of the corresponding vehicle is a member; and
performing collective billing of a parking fee and an electric vehicle charging fee according to information of the member by retrieving the information of the member who manages the electric vehicle matching the vehicle number from the database and by receiving an entry time of the vehicle number from a parking control system after the electric vehicle charging service server completes charging of the electric vehicle.

2. The method of claim 1, wherein the displaying of the vehicle number on the display device or outputting of the vehicle number in the voice through the voice output device further comprises:
receiving, by the electric vehicle charging service server, confirmation of whether the vehicle number matches or not from the owner of the vehicle by outputting the vehicle number to the display device or the voice output device of the electric vehicle charger.

3. The method of claim 1, wherein the confirming of the membership status further comprises:
determining, by the electric vehicle charging service server, the membership status on the basis of vehicle information corresponding to the confirmed vehicle number; and
performing, by the electric vehicle charging service server, a billing function on the basis of the membership status.

4. The method of claim 1, further comprising:
providing, by the electric vehicle charging service server, a selection of whether to perform membership registration to the owner of the vehicle when the owner of the corresponding vehicle is determined to be the non-member in the confirmation of the membership status, and proceeding with a membership registration procedure when the owner of the corresponding vehicle selects the membership registration; and
performing the collective billing of the parking fee and the electric vehicle charging fee by requesting the parking fee of the corresponding vehicle to the parking control server connected to the electric vehicle charging service server through a network.

5. The method of claim 1, further comprising:
operating the electric vehicle charging service server by generating a connection signal when the electric vehicle accesses the electric vehicle charger.

6. An electric vehicle charging system capable of collection and billing of parking fees, the system comprising:
a member information acquisition and transmission part connected to a database for storing member information and configured to provide member confirmation information, which confirms whether an owner of an electric vehicle accessing an electric vehicle charger is a member or not, to an electric vehicle charging service server;
the electric vehicle charging service server configured to acquire a vehicle number from a member DB by confirming membership status through the member information acquisition and transmission part when the electric vehicle accesses; and
a parking fee and electric vehicle charging fee collective billing part configured to perform, after charging is completed, collective billing of a parking fee and an electric vehicle charging fee according to the member information of the member who manages the electric vehicle.

7. The system of claim 6, wherein the member information acquisition and transmission part operated in the electric vehicle charger comprises:
a tagging and insertion part configured to receive information by tagging or inserting a plastic card having a communication function; and
a QR code part configured to acquire the member information through a recognition part including a two-dimensional or three-dimensional QR code.

8. The system of claim 6, further comprising:
a license plate input part configured to receive the vehicle number through an LCD screen of the charger or the license plate recognized by a user's mobile communication device or a user's voice.

9. A parking fee billing method using an electric vehicle charging system capable of collection and billing of parking fees, the method comprising:
recognizing, by a parking control server, a license plate when an electric vehicle enters, and allowing the electric vehicle to proceed with parking;
confirming, by a member information acquisition and transmission part, whether a member or a non-member meets a condition for charging after the parking;
acquiring, by the member information acquisition and transmission part, a vehicle number or a phone number through a membership card or a smartphone in a case of the member, or acquiring the vehicle number or the phone number through an input part in a case of the non-member;
acquiring the vehicle number through the membership card or the smart phone or a license plate input part, setting information on parking fee and charging fee processing by an electric vehicle charging service server, and displaying the information on a display device of an electric vehicle charger;
setting, by the electric vehicle charging service server, charging termination and information guidance, and displaying the same on the display device of the electric vehicle charger;
performing a charging service by the electric vehicle charging service server;
terminating the charging by the electric vehicle charging service server; and
performing a billing function according to the parking fee and the charging fee corresponding to the vehicle number or the phone number.

10. The method of claim 9, wherein, in the setting of the information on the parking fee and charging fee processing by the electric vehicle charging service server, the electric vehicle charging service server sets discount or additional service information, so as to display the discount or additional service information on the display device of the electric vehicle charger and apply the discount or additional service information to a discount additional service.

11. The method of claim 9, further comprising:
confirming, by the electric vehicle charging service server, whether the vehicle number acquisition is correctly performed, and entering and confirming the vehicle number again when the vehicle number is incorrectly entered.

12. The method of claim 9, further comprising:
recognizing, by the parking control server, the license plate when the vehicle exits;
confirming, by the parking control server, whether the parking fee is collected by the charging service server;
calculating and collecting, by the parking control server, the parking fee when the parking fee is not collected by the charging service server; and
proceeding, by the parking control server, with a vehicle exit process of raising a blocking bar.

13. The method of claim 3, further comprising:
providing, by the electric vehicle charging service server, a selection of whether to perform membership registration to the owner of the vehicle when the owner of the corresponding vehicle is determined to be the non-member in the confirmation of the membership status, and proceeding with a membership registration procedure when the owner of the corresponding vehicle selects the membership registration; and
performing the collective billing of the parking fee and the electric vehicle charging fee by requesting the parking fee of the corresponding vehicle to the parking control server connected to the electric vehicle charging service server through a network.
